(19) United States
(12) Patent Application Publication
(10) Pub. No.: US 2026/0364608 A1
(43) Pub. Date: Nov. 19, 2026

(54) SYSTEMS AND METHODS FOR MAGNETICALLY SEPARATING MIXTURES

(71) Applicant: SomaLogic Operating Co., Inc., Boulder, CO (US)

(72) Inventors: Michael BARICH, Berthoud, CO (US); Patrick NOONAN, Golden, CO (US); Tracy R. KEENEY, Firestone, CO (US); Joy BOYD, Broomfield, CO (US)

(21) Appl. No.: 19/152,808

(22) PCT Filed: Feb. 1, 2024
(86) PCT No.: PCT/US2024/014044

§ 371 Date: Jul. 31, 2025

Related U.S. Application Data
(60) Provisional application No. 63/483,173, filed on Feb. 3, 2023.

(51) Int. Cl. B03C 1/01; B03C 1/28; G01N 1/40

(52) U.S. Cl. CPC B03C 1/01; B03C 1/288; G01N 1/4077; B03C 2201/18; B03C 2201/26

(57) ABSTRACT

A method for magnetically separating a mixture includes: agitating a plate comprising one or more sample vessels containing the mixture; instructing, by a motor controller, a motor to translate an array of magnets between a first vertical position and a second vertical position according to a predetermined function of time, causing magnetic particles to form into pellets within the one or more sample vessels; and aspirating fluid from the sample vessels. The predetermined function of time is determined based on minimizing loss of magnetic particles to a desired degree during the step of aspirating.

### CROSS-REFERENCES

The following applications and materials are incorporated herein, in their entireties, for all purposes: U.S. Provisional Patent Application Ser. No. 63/483,173, filed Feb. 3, 2023.

### FIELD

This disclosure relates to systems and methods for mixing and separating mixtures. More specifically, the disclosed embodiments relate to magnetic separation methods.

### INTRODUCTION

Molecular assays involve numerous mixing and washing steps which isolate target molecular compounds from contaminants. This is often achieved by introducing a functionalized surface which binds the target materials. Generally, after the target molecules have bound to the surface, the mixture is washed with a wash fluid, mixed well, and the wash fluid is removed. After repeated washing, mixing, and fluid removal, the target molecules are released from the surface and collected.

While some separation methods functionalize the surface of the mixing vessel itself, it is also common to functionalize suspended colloidal beads. Separation after washing is typically achieved by centrifugation or vacuum filtration. Another common approach uses magnetic beads. A strong permanent magnet brought close to the mixing vessel can separate the particles from the fluid in minutes or seconds. Magnetic separation typically makes use of colloidal magnetic beads ranging in size from 1-100 micrometers. The beads are functionalized, so that desired target biomolecules or molecular compounds attach to the magnetic beads. By adding a mixture of biomolecules to a solution of colloidal magnetic beads one can preferentially immobilize a specific subset of the mixture by preparing magnetic beads having specific affinities for that subset. For instance, magnetic beads may be coupled to streptavidin, which can be used to capture biotin-labeled target molecules such as antigens, antibodies, nucleic acids, or proteins.

Mixing steps generally occur in small sample vessels, such as test tubes or vials, or collections of sample vessels, such as strips or plates of microwells. For manual assays, sample vessels are generally placed in a rack containing strong (e.g., rare earth) permanent magnets. The magnets precipitate the magnetic beads to the location where the magnetic field is the strongest. Separation occurring purely under the action of gravity may take hours or days, depending on bead size, and collects the beads at the bottom of the vessel. Separating the mixture under the action of magnets causes the magnetic beads to precipitate towards the pole of the magnet. For a cylindrical magnet, this will be near the ends of the cylinder. As magnetic forces applied to the beads can be many times greater than gravity, the beads may precipitate out of the mixture in minutes instead of hours.

After separation, the magnetic beads collect in a pellet, which appears as a dark droplet in otherwise clear fluid. At this point, the pellet contains the desired subset of molecules attached to the beads, and the fluid contains contaminants and other molecules that are not of interest in the assay.

The fluid may be aspirated from the sample vessels, for example, by inserting a pipette tip into the vessel at a location displaced from the pellet and carefully drawing out the fluid, carrying away the contaminants and unwanted molecules. Ideally, none of the magnetic beads are aspirated, but in practice some percentage of beads may remain in suspension after separation, in which case they may be aspirated. In some instances, the action of aspiration also may wash some beads away from the pellet. Some amount of bead loss is generally an accepted issue in the field, but efforts are made to minimize this loss.

An initial aspiration of is followed by a series of washes, in which the vessel is removed from the magnet stand and subsequently filled with neutral buffer solutions. After each wash, the filled vessel is mixed, resuspending the magnetic beads and diluting any original fluid captured between beads in the pellet. The steps of magnetic separation, fluid aspiration, washing, and mixing, are repeated until a desired amount of unwanted molecules are washed away. In a final step, the selected subset of materials are released from the magnetic beads by a chemical or physical process, at which point the target molecules may be detected or prepared for detection.

In some examples, known magnetic separation systems comprise racks of sample vessels and two-dimensional arrays of fixed magnets. In these systems, a user manually places the sample vessels on top of the magnetic arrays. In other examples, magnetic separation systems comprise machines that can extend the magnets into position and retract as needed, which aids with automating workflows, such as when workflows include liquid handling (AKA pipetting) robots which wash and resuspend the magnetic beads without human interactions.

While known magnetic separation systems achieve shorter separation times than gravitational separation alone, current magnetic systems separate the mixture with the magnet in a single position. Accordingly, a magnetic field from the magnet is not applied evenly to the mixture. In some examples, the magnet is disposed beneath the sample wells, resulting in a comparatively long separation time, as the magnetic force is felt relatively weakly by magnetic beads near the meniscus of the sample mixture. In some examples, the magnet is disposed adjacent to the meniscus of the sample mixture, which may result in weak magnetic force experienced by magnetic beads near the bottom of the sample vessel. This weak force may lead to long separation times. In some examples, beads may be left at the bottom of the sample well, which are then aspirated when the fluid is aspirated. After a series of successive washes, resuspensions, separations, and aspirations, successive cycles of bead loss due to weak magnetic separation forces can lead to greater than acceptable levels of overall bead loss.

### SUMMARY

The present disclosure provides systems, apparatuses, and methods relating to systems and methods for magnetically separating mixtures.

In some examples, a method for magnetically separating magnetic beads from a fluid includes: sending one or more commands to a motor controller, wherein the commands correspond to a desired movement path as a function of time, and wherein the motor controller causes a motor to cause relative motion between one or more sample vessels and an array of magnets, such that the array of magnets are transitionable between the stowed position and the deployed position; and transitioning the array of magnets between the stowed position and the deployed position along the desired movement path as a predetermined function of time; wherein the magnets are spaced apart from bottom ends of one or more sample vessels containing the fluid when the magnets are in the stowed position; wherein the one or more sample vessels contain magnetic beads suspended by the fluid; and wherein a first pole of each magnet is aligned with a meniscus of fluid in an adjacent sample vessel when the magnets are in the deployed position.

In some examples, a method for magnetically separating a mixture includes: agitating a plate comprising one or more sample vessels containing the mixture; instructing, by a motor controller, a motor to translate an array of magnets between a first vertical position and a second vertical position according to a predetermined function of time, causing magnetic particles to form into pellets within the one or more sample vessels; and aspirating fluid from the sample vessels; wherein the predetermined function of time is determined based on minimizing loss of magnetic particles to a desired degree during the step of aspirating.

In some examples, a system for magnetically separating magnetic beads from a fluid includes: a plurality of sample vessels arranged in a first array; a plurality of magnets arranged in a second array offset from the first array such that the plurality of magnets are extensible into spaces between the sample vessels; a motor configured to vertically translate the plurality of magnets between: (a) a first position, wherein a first pole of each magnet is substantially level with or below bottom ends of the sample vessels; and (b) a second position, wherein the first pole is substantially level with or above a meniscus of fluid within the sample vessels; and a controller configured to vary a speed of the motor as a predetermined function of time, such that a single bead pellet is formed within each sample vessel.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of a first illustrative magnetic separation system in accordance with aspects of the present disclosure.

FIG. 2 is a diagram depicting magnetic field lines and forces experienced by 1-micron magnetic beads at varying distances from the pole of a magnet in an exemplary magnetic separation system.

FIG. 3 is an illustrative magnet movement path as a first function of time.

FIG. 4 is an illustrative magnet movement path as a second function of time.

FIG. 5 is an illustrative magnet movement path as a third function of time.

FIG. 6 is an illustrative magnet movement path as a fourth function of time.

FIG. 7 is an illustrative magnet movement path as a fifth function of time.

FIG. 8 is a schematic diagram depicting a sample vessel after application of a static magnetic field at a first height in an exemplary magnetic separation system.

FIG. 9 is a schematic diagram depicting a sample vessel after application of a static magnetic field at a second height in an exemplary magnetic separation system.

FIG. 10 is a schematic diagram depicting a sample vessel after translating a magnet between a stowed position and a deployed position as a predetermined function of time in an exemplary magnetic separation system, according with aspects of the present disclosure.

FIG. 11 is a photograph depicting three illustrative sample vessels after translating a magnet between a stowed position and a deployed position at different travel speeds.

FIG. 12 is an isometric view of a second illustrative magnetic separation system in accordance with aspects of the present disclosure.

FIG. 13 is an isometric view of the illustrative array of wells and the illustrative array of magnets of the magnetic separation of system of FIG. 12, depicted with the magnets in a stowed position.

FIG. 14 is an isometric view of the illustrative array of wells and the illustrative array of magnets of the magnetic separation of system of FIG. 12, depicted with the magnets in a deployed position.

FIG. 15 is a flow chart depicting steps of an illustrative method for magnetically separating a mixture according to the present teachings.

FIG. 16 is a schematic diagram of a plurality of magnets disposed in a stowed position, spaced apart from a plurality of wells, each including a suspended mixture.

FIG. 17 is a schematic diagram of a plurality of magnets disposed in a deployed position, substantially aligned with a meniscus of a separated fluid within a plurality of wells.

FIG. 18 is a schematic diagram depicting aspiration of fluid within a plurality of sample vessels after magnetic separation of a mixture.

### DETAILED DESCRIPTION

Various aspects and examples of systems and methods for magnetically separating mixtures are described below and illustrated in the associated drawings. Unless otherwise specified, systems and methods for magnetically separating mixtures in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first,” “second,” and “third” are used to distinguish or identify various members of a group, or the like, and are not intended to show serial or numerical limitation.

“AKA” means “also known as,” and may be used to indicate an alternative or corresponding term for a given element or elements.

“Elongate” or “elongated” refers to an object or aperture that has a length greater than its own width, although the width need not be uniform. For example, an elongate slot may be elliptical or stadium-shaped, and an elongate candlestick may have a height greater than its tapering diameter. As a negative example, a circular aperture would not be considered an elongate aperture.

“Processing logic” describes any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (Al) accelerators, digital signal processors (DSPs), and/or any other suitable combination of logic hardware.

A “controller” or “electronic controller” includes processing logic programmed with instructions to carry out a controlling function with respect to a control element. For example, an electronic controller may be configured to receive an input signal, compare the input signal to a selected control value or setpoint value, and determine an output signal to a control element (e.g., a motor or actuator) to provide corrective action based on the comparison. In another example, an electronic controller may be configured to interface between a host device (e.g., a desktop computer, a mainframe, etc.) and a peripheral device (e.g., a memory device, an input/output device, etc.) to control and/or monitor input and output signals to and from the peripheral device.

Directional terms such as “up,” “down,” “vertical,” “horizontal,” and the like should be understood in the context of the particular object in question. For example, an object may be oriented around defined X, Y, and Z axes. In those examples, the X-Y plane will define horizontal, with up being defined as the positive Z direction and down being defined as the negative Z direction.

“Providing,” in the context of a method, may include receiving, obtaining, purchasing, manufacturing, generating, processing, preprocessing, and/or the like, such that the object or material provided is in a state and configuration for other steps to be carried out.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

### Overview

In general, a method of magnetically separating a mixture in accordance with the present teachings includes agitating one or more sample vessels containing the mixture, such that components within the mixture are resuspended by the solution; and translating one or more magnets relative to the one or more sample vessels at a preselected magnet movement path as a function of time. In some examples, translating the one or more magnets includes translating and/or transitioning the magnets between a stowed position and a deployed position at the preselected magnet movement path as a function of time relative to the sample vessels. When the magnets are in the stowed position, the magnets are disposed beneath and spaced apart from an imaginary plane defined by bottom ends of the one or more sample vessels. When the magnets are in the fully deployed position, the magnets are extended such that each magnet is adjacent to one or more sample vessels (e.g., between two sample vessels) and a first pole of each magnet may be substantially aligned with a meniscus of the mixture.

In some examples, translating the one or more magnets relative to the one or more sample vessels includes translating the sample vessels, for instance between a first position and a second position. In some cases, all of the relative motion between the magnets and the sample vessels may be accomplished through motion of the sample vessels. In some cases, both the magnets and the sample vessels may undergo motion. In some cases, only the magnets may move.

The mixture comprises a plurality of functionalized magnetic beads configured such that a desired subset of mixture components binds and/or attaches to the magnetic beads and the desired subset of mixture components is attracted to the magnets. Accordingly, after sufficient exposure to the magnetic force, the magnetic beads form a bead pellet at a vertical height corresponding to a vertical height of the first pole of the magnet. The term “bead pellet” refers to a region (e.g., volume) of the sample vessel where a concentration of the magnetic beads exceeds a concentration of the original mixture. In some examples, magnetic beads within the bead pellet are packed, gathered, and/or clustered such that the magnetic beads are touching each other. In some examples, the bead pellet may be additionally and/or alternatively referred to as a magnetic pellet, as the bead pellet comprises magnetic beads. The one or more magnets travel (e.g., between a stowed position and a deployed position) as a predetermined function of time configured to maximize magnetic force applied to the magnetic beads. As magnetic force experienced by each magnetic bead depends on a distance from the face of the magnet, moving the one or more magnets relative to the one or more sample vessels ensures that magnetic force is evenly experienced by magnetic beads dispersed throughout a mixture. Accordingly, magnetic beads disposed closer to bottom ends of the one or more sample vessels and magnetic beads disposed closer to top ends of the one or more sample vessels experience magnetic force for similar periods of time.

The predetermined function of time may vary based on properties of the magnetic beads, the mixture fluid, and/or the desired outcome of a separation operation. In some examples, the predetermined function of time is calculated based on bead size. In some examples, the predetermined function of time is calculated based on a viscosity of the mixture fluid. In some examples, the predetermined function of time is calculated based on a size, strength, and/or shape of the magnet. In some examples, the predetermined function of time is calculated based on a geometry of the sample vessels. In some cases, the predetermined function of time may be experimentally determined or theoretically calculated to meet any desired criteria, such as minimizing unwanted losses of magnetic beads during a subsequent aspiration step.

The predetermined function of time may include any suitable path or series of velocities at which the magnet and/or sample vessels may travel relative to each other. In some examples, the magnet travels from the stowed position to the deployed position at a constant speed configured to maximize pellet formation. In some examples, a speed of the magnet increases as the magnet travels from the stowed position to the deployed position. In some examples, the magnet speed decreases as the magnet travels from the stowed position to the deployed position. In some examples, the magnet speed is highest at a midpoint between the stowed position and the deployed position. In some examples, the magnet speed is lowest at a midpoint between the stowed position and the deployed position. In some examples, the magnet travels toward the deployed position, reverses direction to travel toward the stowed position, and reverses direction to travel again toward the deployed position. In some examples, the magnet travels from the stowed position to the deployed position in a stepwise manner, such that the magnet travels in a plurality of distinct stages, with pauses between the stages. Similarly, in some examples, the sample vessels travel relative to the magnet as a predetermined function of time such as those described above.

The one or more sample vessels and the one or more magnets may have any suitable size, shape, and/or arrangement. In some examples, the one or more sample vessels comprise a plurality of wells arranged in an array, such as a 96-well plate. In some examples, the one or more sample vessels each comprise a microcentrifuge tube. The one or more magnets may have any suitable shape, such as cylindrical, bar, ring, oval, needle, and/or the like. The one or more magnets may be arranged in any suitable orientation with respect to the one or more sample vessels. For example, the one or more sample vessels may comprise a 96-well plate, and the one or more magnets may each comprise an elongate (e.g., cylindrical, bar, etc.) magnet configured to be extended between the wells of the 96-well plate. In some examples, the one or more sample vessels may each comprise a discrete microcentrifuge tube, and the one or more magnets each comprise a ring magnet through which the microcentrifuge tube may extend when the magnets are in a deployed position.

In some examples, the method of magnetically separating a mixture includes sending one or more commands to a motor controller, wherein the one or more commands correspond to a preselected magnet movement path as a function of time. In these examples, the motor controller instructs a motor to translate the array of magnets from the stowed position to the deployed position.

Aspects of magnetic separation systems and methods may be embodied as a computer method, computer system, or computer program product. Accordingly, aspects of the magnetic separation systems and methods may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the magnetic systems and methods may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of systems and methods for magnetically separating mixtures may be written in one or any combination of programming languages, including an object-oriented programming language (such as Java, C++), conventional procedural programming languages (such as C), and functional programming languages (such as Haskell). Mobile apps may be developed using any suitable language, including those previously mentioned, as well as Objective-C, Swift, C #, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the systems and methods for magnetically separating mixtures may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the systems and methods for magnetically separating mixtures. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of illustrative systems and methods for magnetically separating mixtures. The examples in these sections are intended for illustration and should not be interpreted as limiting the scope of the present disclosure. Each section may include one or more distinct embodiments or examples, and/or contextual or related information, function, and/or structure.

### A. Illustrative First Magnetic Separation System

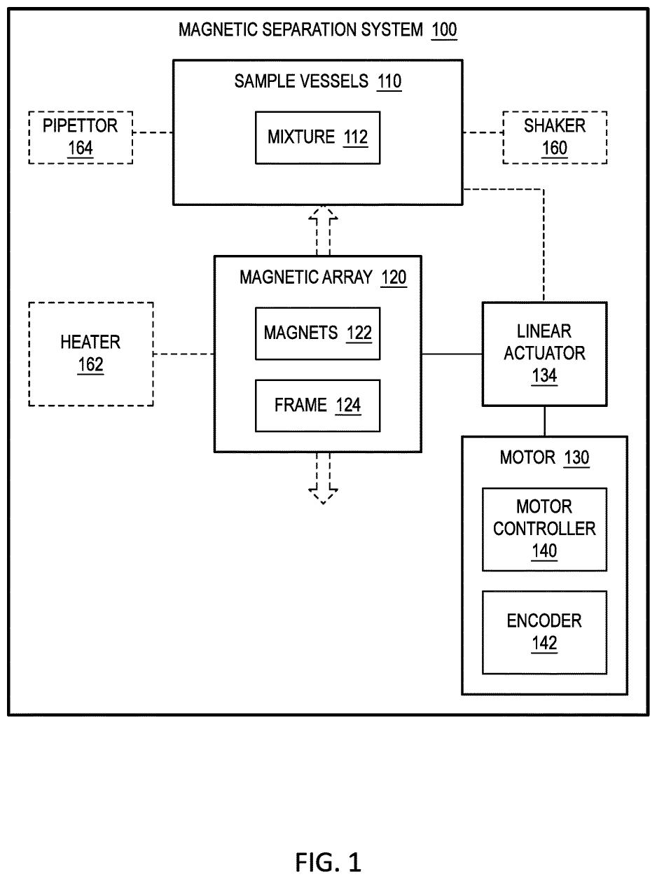

As schematically depicted by FIG. 1, this section describes an illustrative magnetic separation system 100. Magnetic separation system 100 is an example of systems for magnetically separating mixtures, as described above.

Magnetic separation system 100 includes a plurality of (i.e., one or more) sample vessels, wells, or vials 110, and an array of (i.e., one or more) magnets 120 operatively coupled to a motor 130 such that operating the motor extends and retracts the plurality of magnets relative to the sample vessels. In some examples, motor 130 extends and retracts the plurality of magnets into and out of spaces between the sample vessels. Sample vessels, wells, or vials 110 are configured to contain a mixture 112 comprising at least a fluid and a plurality of magnetic beads mixed with the fluid. In some examples, magnetic separation system 100 is configured to separate target molecular compounds and/or biomolecules from non-targeted molecules, wash fluids and contaminants. In these examples, the magnetic beads are functionalized such that the desired molecular compounds and/or biomolecules bind to the magnetic beads, such as through the binding of streptavidin in the beads with biotin-labeled target molecules such as target antigens, antibodies, nucleic acids, or proteins. Accordingly, separating the magnetic beads from the fluid separates the desired molecular compounds and/or biomolecules from other elements of the fluid. The one or more sample vessels may have any suitable size, shape, and/or arrangement. In some examples, sample vessels 110 are arranged in a symmetric array, such that the vessels are arranged in a plurality of rows and columns and a plurality of spaces, apertures, or holes therebetween through which the plurality of magnets may extend and retract. In some examples, the one or more sample vessels each comprise a microcentrifuge tube. In exemplary system 100, array of magnets 120 comprises a plurality of magnets 122 coupled to an underlying plate, rig, or frame 124 such that each magnet extends transversely from an imaginary plane defined by the underlying plate. Accordingly, at least one pole of each magnet is spaced apart from the underlying plate, such that the at least one pole of each magnet may be extended and retracted relative to the sample vessels. In some examples, magnets 120 have a sufficient length such that the at least one pole of the magnet is extended and retracted relative to the sample vessels without the underlying plate contacting the sample vessels. Magnets 120 may have any suitable elongate shape, such as rectangular, cylindrical, ring-shaped, and/or the like, such that a long axis of the magnet extends transversely from the underlying plate. In some examples, magnets 120 are configured such that at least one pole of each magnet may be extended and retracted into and out of spaces between the sample vessels, such as when the sample vessels are arranged in an array.

Magnets 120 may be arranged in any suitable orientation with respect to sample vessels 110. For example, sample vessels 110 may comprise a 96-well plate, and magnets 120 may each comprise an elongate (e.g., cylindrical, bar, etc.) magnet configured to be extended between the wells of the 96-well plate. In some examples, sample vessels 110 each comprise a discrete vessel, such as a microcentrifuge tube and/or the like, and magnets 120 each comprise a ring magnet through which the vessel may extend when the magnets are in a deployed position. In examples wherein magnets 120 each comprise a ring magnet, magnetic beads in the mixture collate into a ring of magnetic beads around the perimeter of the sample vessel.

Magnets 120 may comprise any suitable material capable of maintaining permanent magnetic properties, such as rare-earth materials (e.g., neodymium, samarium-cobalt, etc.), iron, nickel, cobalt, and alloys thereof, and/or the like. In other systems, the magnets may be disposed differently with respect to the sample vessels, and it should be understood that the present teachings do not require any specific arrangement of magnets and sample vessels.

In the example depicted in FIG. 1, plurality of magnets 120 is operatively coupled to motor 130, such that motor 130 is configured to translate the plurality of magnets from a stowed position to a deployed position as a predetermined function of time (e.g., functions of time 150, 152, 154, 156, 158 described below). The plurality of magnets may be operatively coupled to the motor by any suitable linear actuator 134, such as a lead screw, piston, wheel and axle, cam, and/or the like. Accordingly, the motor vertically translates the plurality of magnets between a stowed position, wherein the at least one pole of each magnet is aligned with or spaced apart from an imaginary plane defined by bottom ends of the sample vessels, to a deployed position, wherein the at least one pole of each magnet is adjacent to side walls of the sample vessels (e.g., aligned with a meniscus of the mixture). In some examples, the magnets are spaced apart sufficiently from bottom ends of the sample vessels that magnetic fields reaching then sample vessels are sufficiently weak to not cause unwanted magnetic separation during agitation of the mixture. In some examples, the motor is configured to translate the plurality of magnets such that the magnets contact (i.e., drag and/or scrape along) sides of the sample vessels. When the magnets are disposed at the stowed position (AKA retracted), a magnetic force experienced by the magnetic beads is lower than or substantially equivalent to a force applied by gravity. Accordingly, magnetic beads within the mixture do not separate during agitation of the sample vessels. When the magnets are disposed at the deployed position (AKA extended), a magnetic force experienced by the beads is larger than a force applied by gravity and the magnetic beads are attracted to the at least one pole of each magnet. In some examples, the stowed position and the deployed position are referred to in terms of a vertical magnet height (y). In some examples, the magnet height is 0 mm when the magnet is in the stowed position and from 10 to 12 mm when the magnet is in the deployed position.

More generally, systems according to the present teachings may not involve simple translations caused by linear actuators. In some cases, it may be desirable to move the magnets of a separation system in a more complex path, which may be nonlinear or, if linear, may not be aligned with a vertical axis. All such variations are contemplated by the present teachings.

While in the example depicted in FIG. 1, plurality of magnets 120 is operatively coupled to motor 130, in some examples, sample vessels 110 are operatively coupled to a motor (e.g., to motor 130 by linear actuator 134). In these examples, the sample vessels 110 are translated by the motor relative to the plurality of magnets. In some examples, both sample vessels 110 and magnets 120 are translated relative to each other (i.e., in opposing directions). In some examples, magnets 120 remain stationary while sample vessels 110 are translated relative to the magnets as a predetermined function of time, (e.g., functions of time 150, 152, 154, 156, 158 described below).

The predetermined function of time is configured such that some desired fraction, typically including a majority (e.g., at least half, at least 75%, at least 90%, at least 95%, at least 99%, etc.) of magnetic beads included within the mixture experiences a magnetic force sufficient to collate the magnetic beads into a bead pellet aligned with (e.g., collected, gathered, etc.) the at least one pole of the magnets such that a center of mass of the pellet is at a vertical position aligned with the at least one pole of the magnets. Accordingly, motor 130 is configured to translate the plurality of magnets between the stowed position and the deployed position as a predetermined magnet speed and a predetermined magnet path. The predetermined function of time is configured such that a magnetic force experienced by each bead is greater than a gravitational force experienced by each bead at a sufficient time interval to gather each bead into the bead pellet.

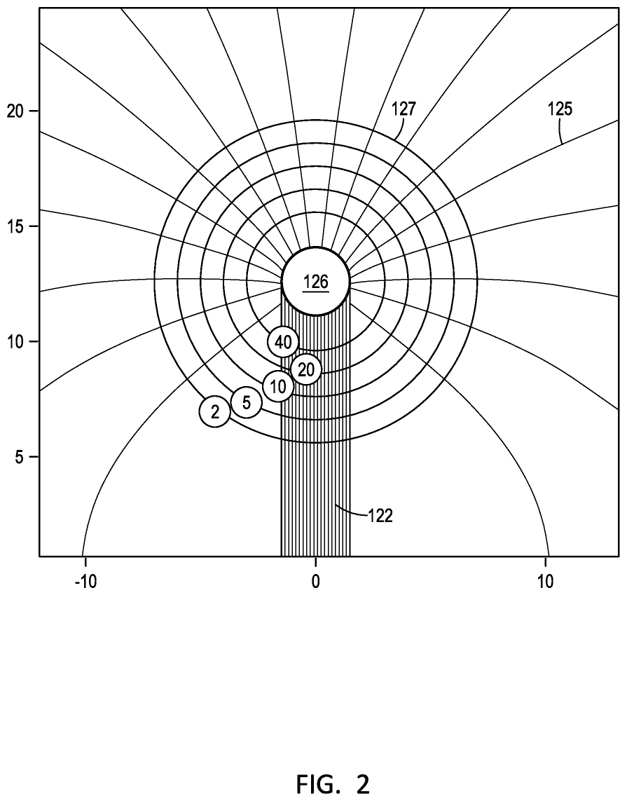

The magnetic force experienced by each magnetic bead depends on a distance between the magnetic bead and the pole of a magnet at a given time. FIG. 2 depicts the relationship between a distance between the pole of a magnet and a magnetic bead, and the magnetic force experienced by the magnetic bead due to the magnet. Magnetic forces experienced by one micron magnetic beads are much greater (20×-60× the force of gravity) when the magnetic bead is closer to a permanent magnet than when the bead is further away (i.e., 7 mm) from the magnet. When a bead is at least 7 mm away from the magnet, the force applied by the magnet does not overcome a force applied by gravity. Accordingly, magnetic beads disposed greater than 7 mm away from the magnet might not be attracted by the magnet sufficiently to avoid sinking to the bottom of the sample vessels. (Cribb, J. A., Meehan, T. D., Shah, S. M., Skinner, K., & Superfine, R. (2010). Cylinders vs. spheres: Biofluid shear thinning in driven nanoparticle transport. Annals of Biomedical Engineering, 38(11), 3311-3322. https://doi.org/10.1007/s10439-010-0084-5).

Specifically, FIG. 2 depicts magnetic field lines and forces mapped around the tip of a cylindrical magnet 122 suitable for use in magnetic separation systems according to the present teachings. Magnetic field lines 125 extend from magnetic pole 126. Forces exerted on the magnetic beads vary due to a combination of the field strength at the bead location and spatial variations of the magnetic field. Concentric force rings 127 around magnetic pole 126 each depict a particular magnetic force applied to a 1-micron magnetic bead, where the forces decrease with distance from the magnetic pole. As depicted by FIG. 2, magnetic beads 3 mm from the magnetic pole experience approximately 40 g (40× the gravitational force) of magnetic force, magnetic beads 4 mm from the magnetic pole experience approximately 20 g of magnetic force, magnetic beads 5 mm from the magnetic pole experience approximately 10 g of magnetic force, magnetic beads 6 mm from the magnetic pole experience approximately 5 g of magnetic force, and magnetic beads 7 mm from the magnetic pole experience approximately 2 g of magnetic force. Magnetic force experienced by the magnetic bead roughly halves with each additional millimeter in distance from the magnetic pole. Accordingly, vertically translating the plurality of magnets 120 relative to the sample vessels as a predetermined function of time includes translating the plurality of magnets such that each magnetic bead is within a preselected distance from the magnetic pole for a preselected time, so that the bead experiences a desired magnetic force as a function of time. While cylindrical magnet 122 is suitable for use in magnetic separations according to the present teachings, magnets 120 may comprise magnets of any suitable shape, such as rectangular, cylindrical, ring-shaped, and/or the like.

Accordingly, moving magnets 120 relative to the sample vessels according to the predetermined function of time can be tailored to exert sufficient magnetic force on each bead included within the mixture to reduce bead loss during aspiration to a desired degree. The predetermined function of time may be determined according to properties of the magnetic beads and the mixture fluid. In some examples, the predetermined function of time is calculated based on bead size. In some examples, the predetermined function of time is calculated based on bead material. In some examples, the predetermined function of time is calculated based on bead concentration. In some examples, the predetermined function of time is calculated based on a total bead mass within the mixture. In some examples, the predetermined function of time is calculated based on a viscosity of the mixture fluid. In some examples, the predetermined function of time is calculated based on a size, strength, and/or shape of the magnet. In some examples, the predetermined function of time is calculated based on a geometry of the wells. In some examples, the predetermined function of time is calculated based on a magnetic strength of the magnetic beads. In some examples, the predetermined function of time is calculated based on a magnetizability of the magnetic beads. In some examples, the predetermined function of time is determined purely experimentally to have a desired effect on the formation of a bead pellet and/or on the loss of beads during subsequent aspiration.

In some examples, the predetermined function of time is determined based on a calculated separation time (T) of the mixture. In some examples, separation time varies based on bead size. The mixture may include any suitable bead size (e.g., 100 μm, 1 μm, 10 μm, etc.) and have any suitable separation time (e.g., 10 seconds-1 minute, 1-5 minutes, 5-30 minutes, 30 minutes-2 hours, greater than 2 hours, etc.). For example, a mixture including 100 μm beads may have a separation time of approximately 45 seconds to one minute. Accordingly, the predetermined function of time may move the magnets between the stowed position and the deployed position within a 45 second to one minute time interval. In some examples, the predetermined function of time includes moving the magnet for a predetermined fraction of the separation time. In some examples, the predetermined function of time includes extending the magnet over a time interval of at least 10% of the calculated separation time. For example, the mixture may have a separation time of 45 seconds, and the predetermined function of time includes extending the magnet over an approximately 5-7 second time interval. In some examples, the predetermined function of time includes extending the magnet over a time interval at least 25% of the calculated separation time. For example, the mixture may have a separation time of 45 seconds, and the predetermined function of time includes extending the magnet over an approximately 11-13 second time interval. In some examples, the predetermined function of time includes extending the magnet over a time interval of at least 50% of the calculated separation time. In some examples, the predetermined function of time includes extending the magnet over a time interval of at least two-thirds of the calculated separation time. For example, the mixture may have a separation time of 45 seconds, and the predetermined function of time includes extending the magnet over an approximately 30 second time interval. In some examples, the predetermined function of time includes extending the magnet over a time interval at least 75% of the calculated separation time. In some examples, the mixture may have a total bead mass between 10 and 20 μg.

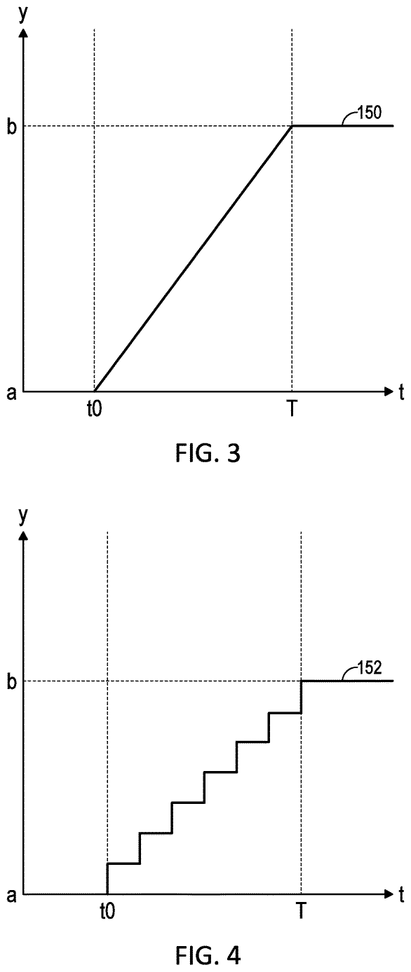

FIGS. 3-7 depict exemplary functions of time 150, 152, 154, 156, 158 suitable for moving magnets 120 to achieve a desired effect on separation time, pellet formation, and/or bead loss during aspiration. While FIGS. 3-7 depict illustrative functions of time suitable for use in systems and methods according to the present disclosure, a variety of suitable functions may be envisaged by one of ordinary skill in the art. The example of this section focuses on one-dimensional, vertical magnet movement as a function of time, but generally speaking, the magnets in a separation system may be displaced in three dimensions according to any arbitrary function of time, to achieve desired bead separation effects. Similarly, while FIGS. 3-7 depict illustrative functions of time suitable for moving magnets 120 relative to sample vessels 110, similar functions of time may be suitable for moving sample vessels 110 relative to magnets 120. In some examples, suitable functions of time for moving sample vessels 110 may include functions 150, 152 154, 156, 158, inverted over the t-axis.

FIG. 3 depicts a first function of time 150. FIG. 3 depicts a vertical position of the magnets (y) as a function of a time (t). In the function depicted by FIG. 3, the magnets continuously extend between a first vertical position (a) and a second vertical position (b). In some examples, the first vertical position corresponds to a stowed position of the magnets and the second vertical position corresponds to a deployed position. In some examples, the magnets continuously extend between an initial time (t₀) and a calculated separation time (T) of the mixture. In some examples, the magnets continuously extend between an initial time and a time (tₓ) before the calculated separation time (T) of the mixture. In some examples, a travel speed of the magnets corresponds to a motor speed of the motor. In some examples, the motor translates the array of magnets at a speed between 150 and 160 pulses per second. In some examples, the motor translates the array of magnets at a substantially constant speed.

FIG. 4 depicts a second function of time 152. FIG. 4 depicts a vertical position of the magnet (y) as a function of a calculated separation time (T). In the example depicted by FIG. 4, the magnets extend between the stowed position and the deployed position in a series of discrete motion steps, with a pause between each step. In some examples, the discrete steps correspond to pulses of a motor. In some examples, as depicted in FIG. 4, a translation time of the magnets corresponds to a calculated separation time (T) of the mixture. In some examples, a translation time of the magnets is less than the calculated separation time of the mixture.

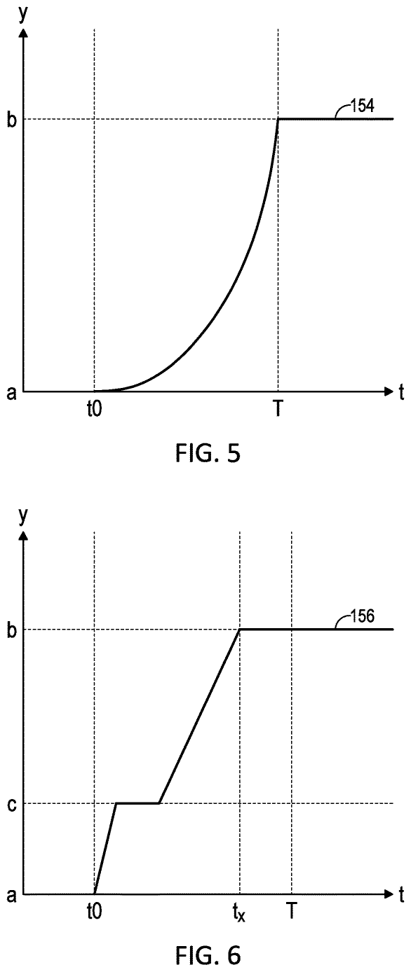

FIG. 5 depicts a third function of time 154. FIG. 5 depicts a vertical position of the magnet (y) as a function of a calculated separation time (T). In the example depicted by FIG. 5, a travel speed of the magnets gradually increases as the magnets extend between the stowed position and the deployed position, until the motion stops when the magnets reach position b. In some examples, as magnetic beads suspended within the mixture travel towards a side of the sample vessel adjacent to an adjacent magnet, a horizontal distance between the magnetic beads and the adjacent magnet decreases, increasing a magnetic force experienced by the magnetic beads. Accordingly, a travel speed of the magnetic beads may increase over time. In some examples, a travel speed of the magnets gradually increases over time, and then gradually decreases over time. In some examples, a travel speed of the magnets gradually decreases over time, and then gradually increases over time.

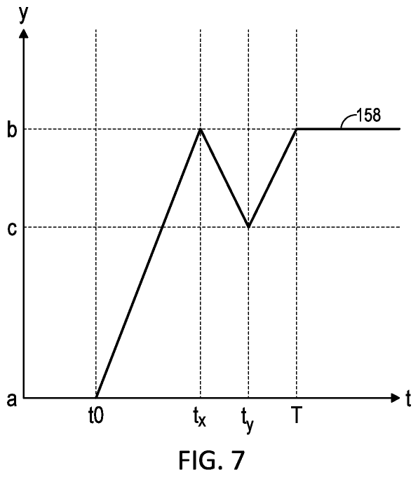

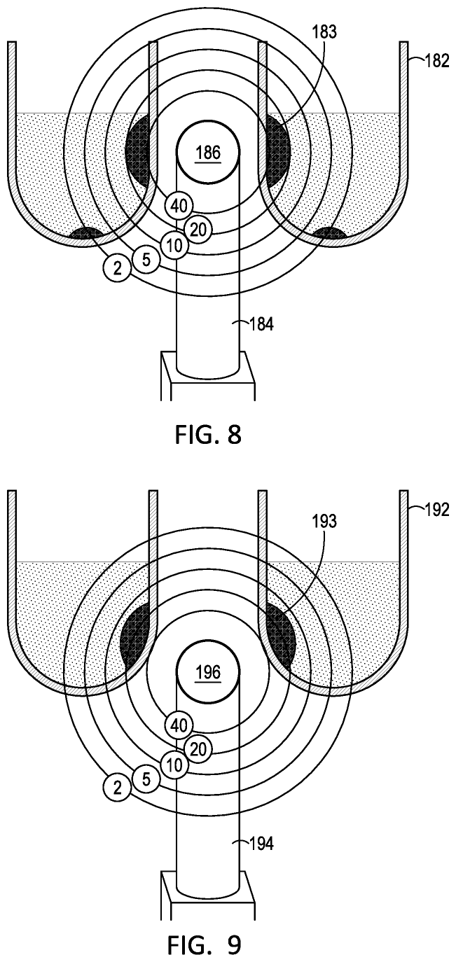

FIG. 6 depicts a fourth function of time 156. FIG. 6 depicts a vertical position of the magnet (y) as a function of a calculated separation time (T). In the example depicted by FIG. 7, the magnets travel from stowed position (a) to an intermediate position (c) at a first extension speed. In some examples, the intermediate position corresponds to a height aligned with bottom ends of the sample vessels. After pausing at the intermediate position for a selected time interval, the magnets travel from the intermediate position to deployed position (b) at a second extension speed. In some examples, the second extension speed is slower than the first extension speed. In the example depicted in FIG. 6, a magnetic force applied to the magnetic beads is augmented by a gravitational force for the selected time interval. After the selected time interval, the magnets are extended between the intermediate position to the deployed position at a slower extension speed, such that suspended magnetic beads disposed closer to the meniscus are collected by the magnet. In the example depicted in FIG. 6, a translation time (tₓ) of the magnets is less than the total separation time of the mixture. The translation time may be configured to be any suitable percentage of the total separation time of the mixture, such as 10%, 25%, 50%, 75%, and/or the like. In some examples, the translation time is equal to the total separation time of the mixture.

FIG. 7 depicts a fifth function of time 158. FIG. 7 depicts a vertical position of the magnet (y) as a function of a calculated separation time (T). In the example depicted by FIG. 7, the magnets extend between a stowed position (a) and a deployed position (b) at a first extension speed between an initial time (t₀) and a first time (tₓ). The magnets then retract from deployed position (b) to an intermediate position (c) at a first retraction speed between first time (tₓ) and second time (t_{y}). After retracting, the magnets extend from intermediate position (c) to deployed position (b) at a second extension speed.

Translating the magnets as a predetermined function of time (e.g., according to a function such as functions 150, 152, 154, 156, 158) may reduce magnetic bead loss associated with aspirating the mixture fluid. During magnetic separation, as performed using magnetic separation system 100, mixture fluid is aspirated after a time (T_{A}) greater than calculated separation time (T) has elapsed. Turning now to FIGS. 9-11 respectively, a sample vessel 110, 182, 192 is depicted adjacent to magnet 122, 184, 194. As described above, sample vessel 110, 182, 192 contains a mixture of magnetic beads and a fluid. Magnet 122, 184, 194 creates a magnetic field 125, which exerts a magnetic force on magnetic beads within the sample vessel. As a result of the magnetic field, the magnetic beads form a bead pellet 114, 183, 193 aligned with magnetic pole 126, 186, 196. Current magnetic separation systems hold magnet 184, 194 at a single vertical position for an entirety of a separation time of the mixture. As discussed further below, holding the magnet at a single vertical position results in increased bead loss when compared with vertically translating the plurality of magnets as a predetermined function of time (e.g., function of time 150, 152, 154, 156, 158, etc.).

FIG. 8 depicts sample vessel 182 with magnet 184 disposed in a deployed position, with magnet 184 aligned with the meniscus of the fluid. As shown, forces exerted on the mixture by magnet 184 are substantially similar to, or less than, a gravitational force exerted on the mixture near a bottom end of the sample vessel. As a result, some magnetic beads sink to the bottom of the sample vessel and are not collected into bead pellet 183. The excess magnetic beads may be aspirated with the sample fluid, resulting in bead loss.

FIG. 9 depicts sample vessel 192 with magnet 194 disposed in an intermediate position, with magnet 194 aligned with a bottom end of the sample vessel. As shown, magnetic beads collect in pellet 193 around magnetic pole 196, as beads near the bottom of the sample vessel experience a magnetic force greater than an exerted gravitational force. However, the bead pellet is disposed near the bottom of the sample vessel. Aspirating fluid from the sample vessel may result in bead loss, as aspirating fluid includes inserting a pipette into the sample vessel such that the pipette is close to the bottom of the sample vessel. The pipette may inadvertently contact the pellet, aspirating magnetic beads.

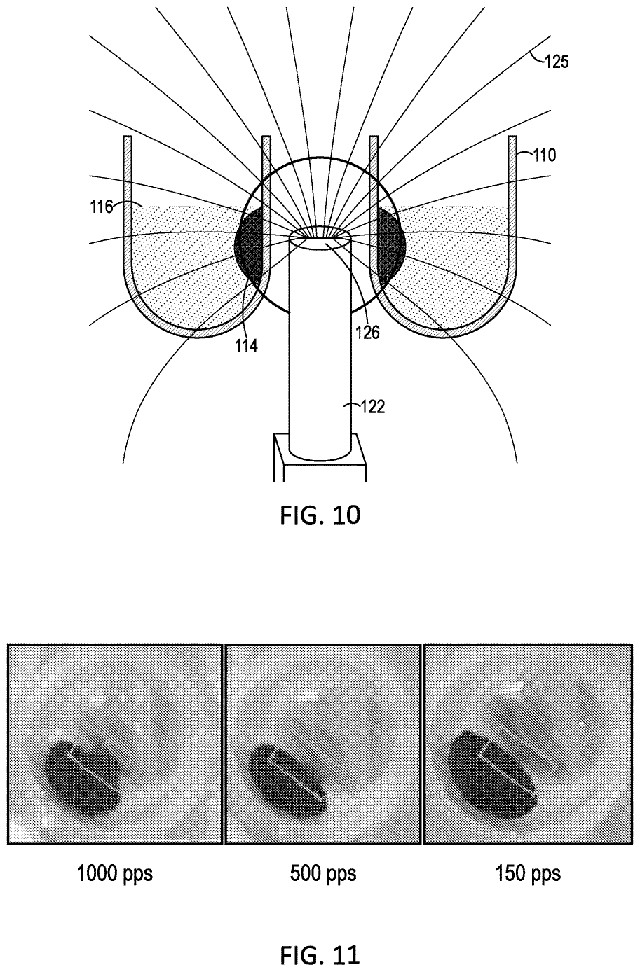

FIG. 10 depicts a pellet location and state resulting from translating magnet 122 between the stowed position and the deployed position as a predetermined function of time (e.g., according to a function such as one of functions 150, 152, 154, 156, 158). After a calculated separation time (T) has elapsed, the magnetic beads have separated virtually completely from the mixture fluid, resulting in minimal bead loss. In the example depicted in FIG. 10, magnet 122 is substantially aligned with a meniscus 116 of the fluid. Accordingly, bead pellet 114 is aligned with the meniscus. As can be seen in FIG. 10, substantially all magnetic beads within the sample vessel are contained within bead pellet 114. Furthermore, bead pellet 114 is spaced apart from the bottom of the sample vessel, facilitating easy removal of the fluid from the sample vessel (e.g., via aspiration, pipetting, etc.).

FIG. 11 is a series of photographs depicting bead pellet shapes achieved at various constant magnet extension speeds. As depicted in FIG. 11, translating the magnets between the stowed position and the deployed position results in larger bead pellets and fewer residual magnetic beads disposed at a bottom end of the sample vessel. When the magnet was translated at a speed of 1000 pps (pulses per second), a visible secondary pellet formed at the bottom of the sample vessel. When the magnet was translated at a speed of 500 pps, residue is visible at the base of the sample vessel, but a discrete bead pellet did not form. When the magnet was translated at a speed of 150 pps, minimal residue is visible, and a bead pellet did not form. Accordingly, translating the magnets at slower speeds reduced bead loss in the example depicted by the photos. In some cases, translating the magnets at variable speeds, or as more complex functions of time, may result in even less bead loss.

In some examples, motor 130 is operatively coupled to a motor controller 140, which instructs the motor to translate the plurality of magnets at the first function of time. In some examples, the motor controller is electronically coupled to encoder 142 such that signals between the motor controller and the motor pass through the encoder. Encoder 142 communicates magnet characteristics, such as magnet height, magnet position, magnet speed, and/or the like to motor controller 140. In some examples, motor controller 140 may update and/or modify the function of time based on the communicated magnet characteristics.

In some examples (referring back to FIG. 1), magnetic separation system 100 further comprises a shaker 160 configured to agitate the mixture. Shaker 160 comprises any suitable apparatus suitable for mixing and/or agitating a mixture, such as a shaker (e.g., linear shaker, orbital shaker, etc.), a rocker, a rotator, and/or the like. Agitating the mixture may resuspend magnetic beads within the mixture fluid, so that the mixture can be separated. In some examples, magnetic separation system 100 further comprises a heater 162 configured to heat the mixture.

In some examples, magnetic separation system 100 further comprises an automatic pipettor 164 configured to aspirate mixture liquid included in the sample vessels. In some examples, automatic pipettor includes an array of pipettes coupled to a motor configured to vertically translate the pipettes into and out of the sample vessels. In some examples, the automatic pipettor includes a motor controller configured to instruct the motor to vertically translate the pipettes into the sample vessels after a calculated aspiration time (TA) has elapsed.

### B. Illustrative Second Magnetic Separation System

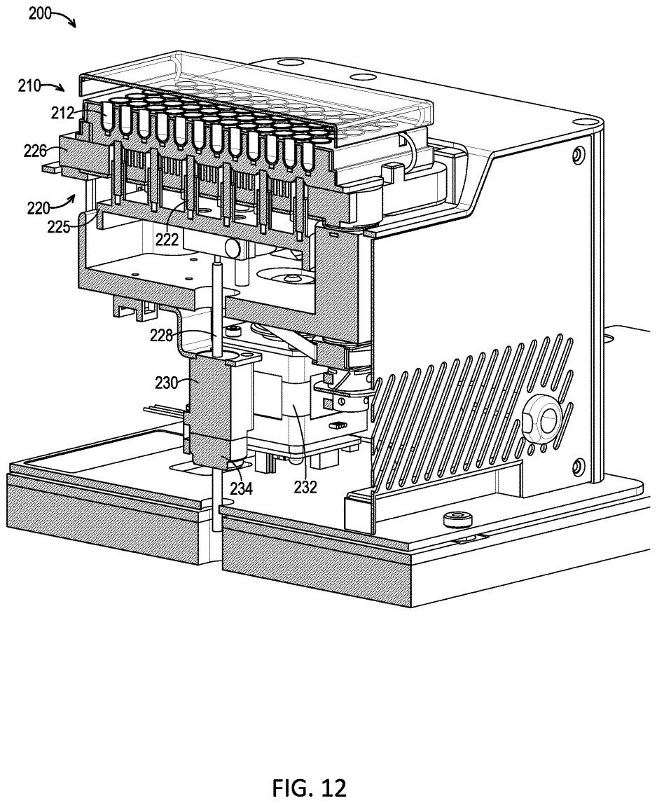

As shown in FIGS. 12-14, this section describes a second illustrative magnetic separation system 200. Magnetic separation system 200 is an example of systems for magnetically separating mixtures according to aspects of the present teachings, as described above. Magnetic separation system 200 is substantially similar to magnetic separation system 100, except as described below.

FIG. 12 depicts magnetic separation system 200. Magnetic separation system 200 comprises an array 210 of sample vessels 212 (AKA a plurality of wells). Each sample vessel is configured to contain a mixture 214 of fluid and magnetic beads (AKA magnetic particles). Sample vessels 212 are arranged in a symmetric array 210, such that each vessel is included in a row and a column. In some examples, the array of sample vessels comprises a microwell plate. In some examples, the plurality of wells comprises a 96-well microwell plate, comprising 8 rows and 12 columns of wells.

Disposed beneath and offset from array 210 is an array 220 of magnets 222. Each magnet is extensible into spaces between two or more sample vessels, such that a tip or pole 224 of each magnet may act on the mixture fluid at a variety of heights. In some examples, array 220 includes 24 cylindrical magnets, arranged such that each magnet, when extended, acts on the mixture fluid primarily within four nearby sample vessels. Magnets 222 are coupled to a magnet plate 225 at a first end such that each magnet extends transversely from the magnet plate. Magnets 222 may have any suitable elongate shape, such that a first pole of each magnet is extensible into spaces between the sample vessels. In the example depicted in FIGS. 12-14, each magnet is a cylindrical permanent magnet. In some examples, a heater plate 226 is further disposed beneath the magnet plate, and is configured to heat the fluid within the sample vessels.

Magnetic separation system 200 further comprises a motor 230 operatively coupled to the magnet plate by a vertical actuator 228. Accordingly, operating motor 230 vertically translates the magnet plate such that magnets 222 extend and retract into spaces between sample vessels 212. In the example depicted in FIGS. 12-14, the vertical actuator is a lead screw, but vertical actuator 228 may comprise any suitable linear actuator, such as a lead screw, piston, wheel and axle, cam, and/or the like. Motor 230 is configured to operate over a range of speeds as instructed by a motor controller 232. Accordingly, motor controller 232 is configured to vary the motor speed at a preselected function of time as described above with respect (for example) to functions of time 150, 152, 154, 156, 158, such that a magnetic force is applied to the mixture by magnets 222 and a magnetic bead pellet is formed within each sample vessel. In some examples, motor 230 further comprises a motor encoder 234 which ensures that a vertical position and a speed of the motor are accurately controlled. In some examples, motor encoder 234 may communicate the vertical position and the speed of the motor to motor controller 232, and motor controller 232 may modify the function of time based on the communicated position and speed.

Motor controller 232 includes processing logic programmed with instructions to carry out a controlling function (i.e., a function of time) with respect to a control element (i.e., motor 230). In some examples, motor controller 232 is configured to interface between a host device (e.g., a desktop computer, a mainframe, etc.) and motor 230 to control and/or monitor input and output signals to and from the motor.

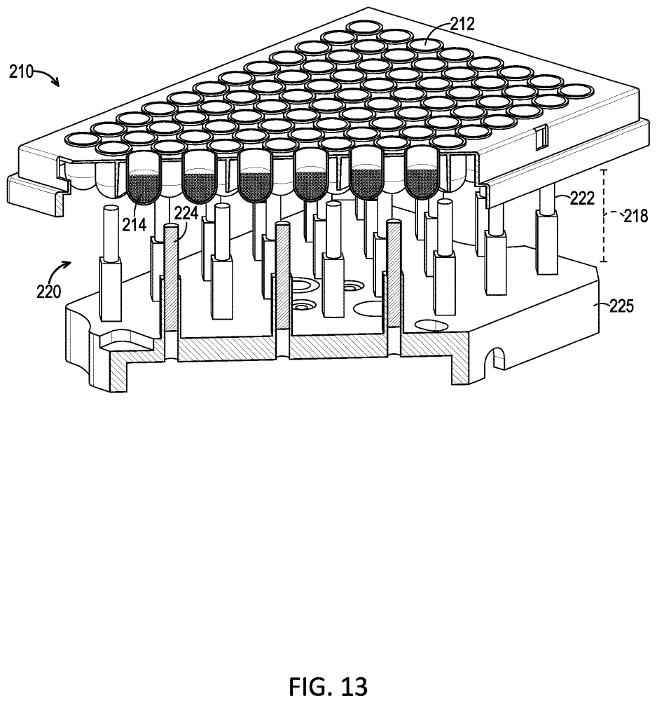

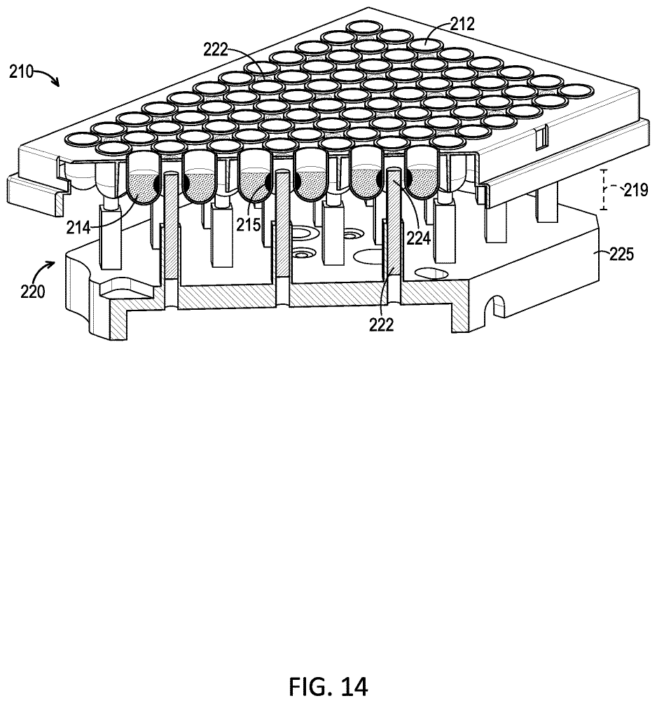

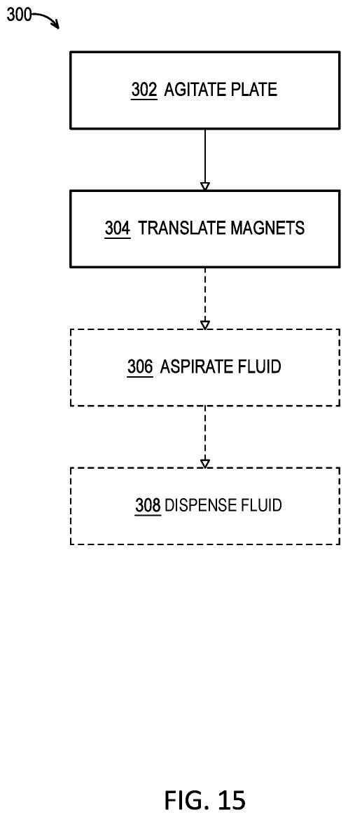

In some examples, motor 230 is configured to translate magnets 222 between a stowed position (see FIG. 13) and a deployed position (see FIG. 14) as a preselected function of time. FIGS. 14 and 15 depict the array 210 of sample vessels 212 and the magnetic array 220 of magnets 222 of magnetic separation system 200. In FIG. 14, magnets 222 are retracted and mixture 214 comprises a plurality of magnetic beads suspended in a mixing fluid. A first pole 224 of each magnet is spaced apart from a plane 216 defined by bottom edges of the ends of the sample vessels. Magnet plate 225 is spaced apart from array 210 by a first distance 218. When magnets 222 are in the stowed position, the magnets are spaced apart from the sample vessels by a sufficient distance such that magnetic beads within the sample vessels are not significantly acted upon by the magnets. In some examples, the first distance is determined or selected such that the sample vessels may be shaken or agitated by a shaker without the vessels contacting the magnets. Accordingly, in some examples, magnetic separation system 200 includes a shaker or agitator 240 configured to agitate the sample vessels, suspending the magnetic beads within the mixture.

In FIG. 14, magnets 222 are disposed in an activated position (AKA deployed position). First poles 224 of magnets 222 are disposed substantially level with a meniscus of the mixture in each sample vessel. Magnet plate 225 is spaced apart from array 210 by a second distance 219, which is less than first distance 218. In other words, the magnet plate is closer to the array in the deployed position than in the stowed position. Magnetic particles within mixtures 214 have formed pellets 215 adjacent to first poles 224. Accordingly, the example depicted in FIG. 14 depicts mixtures 214 after a separation time (T) of the mixture has elapsed.

As is visible in FIG. 15, in this embodiment magnetic array 220 is offset from sample vessel array 210 so that the distal ends of the magnets define a horizontal plane, and magnets 222 are distributed such that each magnet acts primarily on four nearby sample vessels. In other embodiments, the magnets may not by equally offset from the sample vessels at any particular instant of time, the magnets may not include any planar surface or define any common plane, and/or each magnet may act primarily on fewer or greater than four sample wells.

### C. Illustrative Magnetic Separation Method

This section describes steps of an illustrative method 300 for magnetically separating a mixture; see FIG. 15. Aspects of magnetic separation systems 100, 200 may be utilized in the method steps described below. Where appropriate, reference may be made to components and systems that may be used in carrying out each step. These references are for illustration, and are not intended to limit the possible ways of carrying out any particular step of the method.

FIG. 15 is a flowchart illustrating steps performed in an illustrative method 300, and may not recite the complete process or all steps of the method. Although various steps of method 300 are described below and depicted in FIG. 15, the steps need not necessarily all be performed, and in some cases may be performed simultaneously or in a different order than the order shown.

Step 302 of method 300 includes agitating a plurality of sample vessels (e.g., a plate comprising a plurality of wells), such that components within the mixture are resuspended by the solution. Agitating the plurality of sample vessels mixes the magnetic beads (AKA magnetic particles) with the mixture fluid, evenly distributing the magnetic beads within the fluid. In some examples, the mixture fluid is a wash fluid, and agitating the plate washes the magnetic beads. In some examples, agitating the plurality of sample vessels comprises, by a computer, instructing a shaker to agitate the plurality of sample vessels.

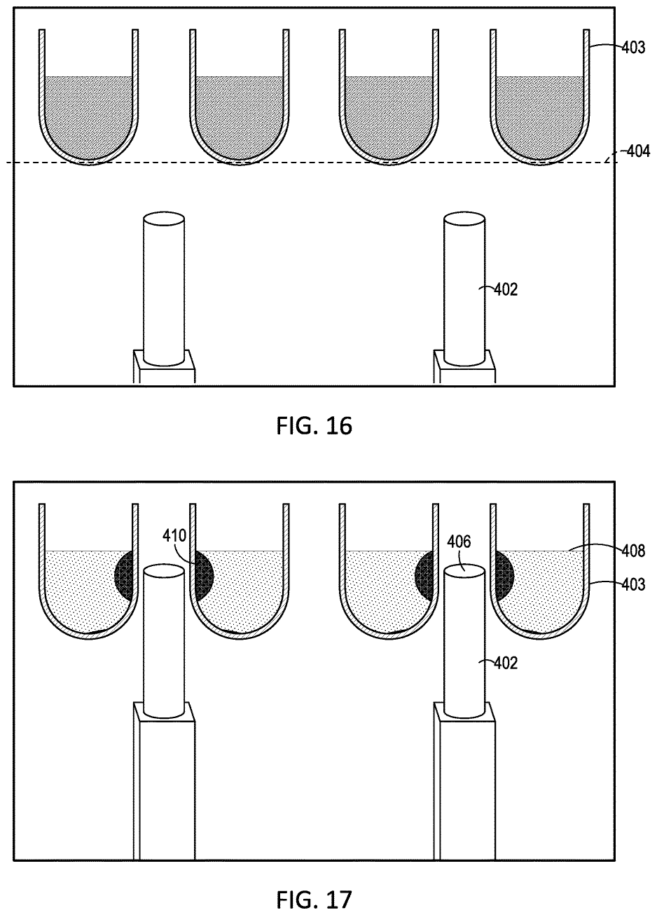

Step 304 of method 300 includes translating an array of magnets relative to the plurality of sample vessels in a preselected movement path (e.g., magnet movement path) as a function of time. In some examples, translating the array of magnets relative to the plurality of sample vessels includes causing relative motion between the plurality of sample vessels and the array of magnets in the preselected magnet movement path as a function of time. In some examples, causing relative motion between the one or more sample vessels and an array of magnets includes translating the array of magnets along the preselected movement path. In some examples, causing relative motion between the one or more sample vessels and the array of magnets includes translating the one or more sample vessels along the preselected movement path. In some examples, translating an array of magnets relative to the plurality of sample vessels includes translating the array of magnets between a stowed position and a deployed position. For example, FIG. 16 depicts a plurality of magnets 402 in the stowed position. In some examples, when the magnets are in the stowed position, the magnets are disposed beneath an imaginary plane 404 defined by bottom ends of sample vessels 403. In some examples, sample vessels 403 are disposed at differing heights, and imaginary plane 404 is defined by a bottom end of a bottommost one of the sample vessels. In some examples, sample vessels 403 are disposed at differing heights and each magnet is spaced apart from bottom ends of adjacent sample vessels. FIG. 17 depicts the plurality of magnets in the deployed position. When the magnets are in the deployed position, magnets 402 are extended between the wells and a first pole 406 of each magnet is substantially aligned with a meniscus 408 of the mixture. As the magnets are extended, magnetic beads within the mixture migrate towards the first pole of each magnet, forming a distinct bead pellet 410. Translating the array of magnets at a preselected magnet movement path as a function of time includes translating the array of magnets at any suitable function of time, such as functions 150, 152, 154, 156, 158 described above. In some examples, translating an array of magnets relative to the plurality of sample vessels includes translating the sample vessels while the magnets remain stationary.

More generally, the motion of the magnets relative to the plurality of sample vessels as a function of time is configured to distribute a magnetic force such that magnetic beads disposed throughout the sample mixture experience a sufficient force to cause the beads to migrate toward the first pole in a desired manner, to form pellets that include a desired fraction of magnetic beads in the sample. As magnetic force experienced by each magnetic bead depends on a distance from the face of the magnet, moving the magnets between the stowed position and the deployed position ensures that magnetic force is experienced by magnetic beads dispersed throughout a mixture. Accordingly, magnetic beads disposed closer to bottom ends of the sample vessels and magnetic beads disposed closer to top ends of the sample vessels experience magnetic force for similar periods of time.

In some examples, the predetermined function of time is determined based on a calculated separation time (T) of the mixture. In some examples, separation time varies based on bead size. The mixture may include any suitable bead size (e.g., 100 μm, 1 μm, 10 μm, etc.) and have any suitable separation time (e.g., 10 seconds-1 minute, 1-5 minutes, 5-30 minutes, 30 minutes-2 hours, greater than 2 hours, etc.). For example, a mixture including 100 μm beads may have a separation time of approximately 45 seconds to one minute. Accordingly, the predetermined function of time may move the magnets between the stowed position and the deployed position within a 45 second to one minute time interval.

In some examples, the predetermined function of time includes moving the magnet for a predetermined fraction of the separation time. In some examples, the predetermined function of time includes extending the magnet over a time interval of at least 10% of the calculated separation time. For example, the mixture may have a separation time of 45 seconds, and the predetermined function of time includes extending the magnet over an approximately 5-7 second time interval. In some examples, the predetermined function of time includes extending the magnet over a time interval at least 25% of the calculated separation time. For example, the mixture may have a separation time of 45 seconds, and the predetermined function of time includes extending the magnet over an approximately 11-13 second time interval. In some examples, the predetermined function of time includes extending the magnet over a time interval of at least 50% of the calculated separation time. In some examples, the predetermined function of time includes extending the magnet over a time interval of at least two-thirds of the calculated separation time. For example, the mixture may have a separation time of 45 seconds, and the predetermined function of time includes extending the magnet over an approximately 30 second time interval. In some examples, the predetermined function of time includes extending the magnet over a time interval at least 75% of the calculated separation time. In some examples, the mixture may have a total bead mass between 10 and 20 μg.

While functions 150, 152, 154, and 156, 158 are suitable for translating the magnets, any suitable function configured based on properties of the magnetic beads and the mixture fluid may be utilized. In some examples, the preselected function of time is calculated based on bead size. In some examples, the preselected function of time is calculated based on a viscosity of the mixture fluid. In some examples, the preselected function of time is calculated based on a size, strength, and/or shape of the magnet. In some examples, the preselected function of time is calculated based on a geometry of the sample vessels. In some examples, the preselected function of time is calculated based on a magnetizability of the magnetic beads. In some examples, the preselected function of time is calculated based on a magnetic strength of the magnetic beads. In some examples, the preselected function of time is determined experimentally to result in desired bead formation and corresponding minimization of bead loss during subsequent aspiration steps.

The preselected function of time may include any suitable path or series of velocities at which the magnet may travel, in one, two, or three dimensions. In some examples, the magnet travels from the stowed position to the deployed position in one direction and at a constant speed configured to maximize pellet formation. In some examples, a speed of the magnet increases as the magnet travels from the stowed position to the deployed position. In some examples, the magnet speed decreases as the magnet travels from the stowed position to the deployed position. In some examples, the magnet speed is highest at a midpoint between the stowed position and the deployed position. In some examples, the magnet speed is lowest at a midpoint between the stowed position and the deployed position. In some examples, the magnet travels toward the deployed position, reverses direction to travel toward the stowed position, and reverses direction to travel again toward the deployed position. Similarly, in some examples, the sample vessels travel relative to the magnet as a predetermined function of time, such as any of those described above. In some examples, both the magnets and the sample vessels may have motions which are predetermined functions of time, resulting in a desired relative motion as a function of time.

In some examples, the method of magnetically separating a mixture includes sending one or more commands to a motor controller, wherein the one or more commands correspond to a preselected magnet movement path as a function of time. In these examples, the motor controller translates the array of magnets from the stowed position to the deployed position. In some examples, the commands include a predetermined motor speed or series of motor speeds. In some examples, the method of magnetically separating a mixture includes, by the motor, causing relative motion between the array of magnets and the sample vessels. In some examples, the method of magnetically separating a mixture includes, by the motor, translating the one or more sample vessels relative to the magnets such that the magnets are translated between the stowed position and the deployed position.

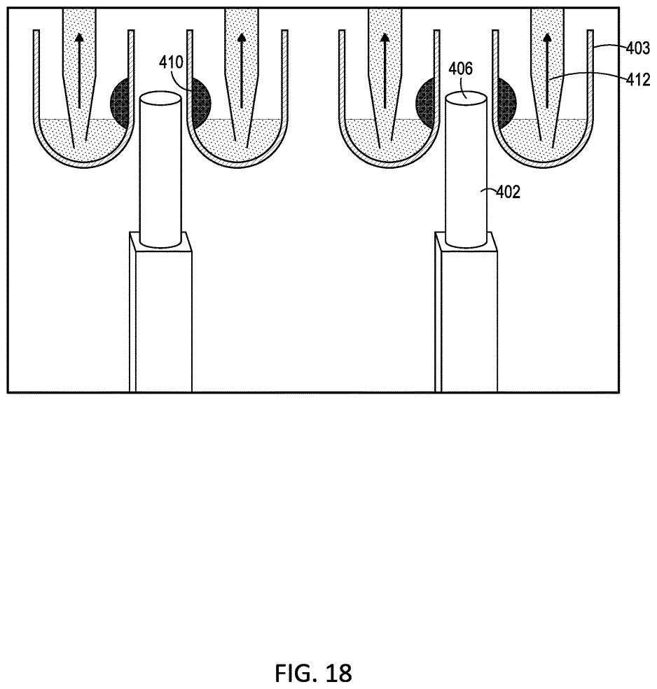

Step 306 of method 300 optionally includes aspirating fluid from the separated mixture. FIG. 18 depicts a separated mixture as described herein, during aspiration. As depicted in FIG. 18, aspirating fluid may include inserting a pipette 412 into each sample vessel, such that a tip of the pipette is near the bottom of the sample vessel. Aspirating fluid further comprises removing fluid from the mixture, via suction. After the fluid has been aspirated, bead pellet 410 remains within the sample vessel. In some examples, after the fluid has been aspirated, the method includes retracting the magnets from the deployed position to the stowed position.

Step 308 of method 300 optionally includes dispensing wash fluid into each sample vessel. After the mixture fluid has been aspirated, as in optional step 306, fluid remains trapped between magnetic beads within the bead pellet. Accordingly, in some examples, method 300 includes pipetting wash fluid (e.g., a neutral buffer solution) into the wells. Retracting the magnets as described above may cause the bead pellet to droop, sag, or otherwise migrate towards the bottom of the sample vessel. Dispensing wash fluid into the sample vessel may further dislodge the bead pellet from the sample vessel wall, resuspending or partially resuspending the magnetic beads and allowing removal of additional unwanted elements from the sample solution.

In some examples, method 300 is repeated two or more times, each repetition including a series of mixing (AKA resuspension), separation, aspiration, and washing steps which remove unwanted molecules (i.e., contaminants) from the mixture. In some examples, method 300 includes releasing the magnetic beads from molecules which were previously coupled to the magnetic beads.

### D. Illustrative Combinations and Additional Examples

This section describes additional aspects and features of systems and methods for magnetically separating mixtures, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A method for magnetically separating magnetic particles from a fluid, the method comprising:
agitating a plate comprising one or more sample vessels, such that the magnetic beads are suspended by the fluid; and
   transitioning an array of magnets between a stowed position and a deployed position along a desired movement path as a predetermined function of time;
wherein the magnets are spaced apart from bottom ends of the one or more sample vessels when the magnets are in the stowed position; and
   wherein a first pole of each magnet is aligned with a meniscus of fluid in an adjacent sample vessel when the magnets are in the deployed position.

A1. The method of paragraph A0, further comprising sending one or more commands to a motor controller, wherein the commands correspond to the desired movement path as a function of time, and wherein the motor controller causes a motor to translate the array of magnets between the stowed position and the deployed position.

A1.1. The method of paragraph A1, wherein the motor controller causes the motor to cause relative motion between the one or more sample vessels and the array of magnets.

A1.2. A method for magnetically separating magnetic beads from a fluid, the method comprising:
sending one or more commands to a motor controller, wherein the commands correspond to a desired movement path as a predetermined function of time, and wherein the motor controller causes a motor to cause relative motion between one or more sample vessels and an array of magnets, such that the array of magnets are transitionable between a stowed position and a deployed position; and
transitioning an array of magnets between the stowed position and the deployed position along the desired movement path as the predetermined function of time;
wherein the magnets are spaced apart from bottom ends of one or more sample vessels containing the fluid when the magnets are in the stowed position;
   wherein the one or more sample vessels contain magnetic beads suspended by the fluid; and
wherein a first pole of each magnet is aligned with a meniscus of fluid in an adjacent sample vessel when the magnets are in the deployed position.

A2. The method of paragraph A1, wherein the motor translates the array of magnets at a speed between 150 and 160 pulses per second.

A3. The method of any of paragraphs A0 through A2, wherein the function of time is determined based on a size of the magnetic beads.

A4. The method of any of paragraphs A0 through A3, wherein the function of time is determined based on a viscosity of the fluid.

A5. The method of any of paragraphs A0 through A4, wherein the function of time is determined based on a strength or size of the magnets.

A6. The method of any of paragraphs A0 through A5, wherein the one or more sample vessels collectively comprise a microwell plate.

A7. The method of paragraph A6, wherein the array of magnets are arranged such that each magnet acts on four wells.

A8. The method of any of paragraphs A0 through A7, wherein the array of magnets are continuously extended between the stowed position and the deployed position.

A9. The method of paragraph A8, wherein the array of magnets are extended between the stowed position and the deployed position at a constant speed.

A10. The method of any of paragraphs A0 through A8, wherein a travel speed of the magnets varies over time.

A11. The method of paragraph A0, wherein the function of time is at least partially determined experimentally to achieve a desired maximum amount of bead loss during subsequent aspiration of the fluid from the sample vessels.

A12. The method of any of paragraphs A0 through A11, wherein the magnets are extended into spaces between the one or more sample vessels when the magnets are in the deployed position.

A13. The method of any of paragraphs A0 through A12, wherein the function of time is determined based on a magnetic strength of the magnetic beads.

A14. The method of any of paragraphs A0 through A13, wherein the function of time is determined based on a magnetizability of the magnetic beads.

A15. The method of any of paragraphs A0 through A14, wherein the function of time includes translating the array of magnets over a time interval of at least 10% of a calculated separation time of the magnetic beads and the fluid.

A16. The method of any of paragraphs A0 through A15, wherein causing relative motion between the one or more sample vessels and an array of magnets includes translating the array of magnets along the desired movement path.

A17. The method of any of paragraphs A0 through A16, wherein causing relative motion between the one or more sample vessels and the array of magnets includes translating the one or more sample vessels along the desired movement path.

B0. A method for magnetically separating a mixture, the method comprising:
agitating a plate comprising one or more sample vessels containing the mixture;
instructing, by a motor controller, a motor to translate an array of magnets between a first vertical position and a second vertical position according to a predetermined function of time, causing magnetic particles to form into pellets within the sample vessels; and
aspirating fluid from the sample vessels;
wherein the predetermined function of time is determined based on minimizing loss of magnetic particles to a desired degree during the step of aspirating.

B1. The method of paragraph B0, wherein the motor translates the array of magnets at a speed between 150 and 160 pulses per second.

B2. The method of paragraph B0 or B1, wherein the predetermined function of time is determined based on a size of magnetic beads included within the mixture.

B3 The method of any of paragraphs B0 through B2, wherein the predetermined function of time is determined based on a viscosity of a fluid included within the mixture.

B4. The method of any of paragraphs B0 through B3, wherein the predetermined function of time is determined based on a strength or size of the magnets.

B5. The method of any of paragraphs B0 through B4, wherein the plurality of sample vessels comprises a microwell plate.

B6. The method of any of paragraphs B0 through B5, wherein the array of magnets is arranged such that each magnet acts on four wells.

B7. The method of any of paragraphs B0 through B6, wherein the array of magnets is continuously extended between the stowed position and the deployed position.

B8 The method of paragraph B7, wherein the array of magnets is extended between the first position and the second position at a constant speed.

B9. The method of any of paragraphs B0 through B7, wherein a travel speed of the array of magnets varies over time.

B10. The method of paragraph B0, further including aspirating fluid from the plurality of sample vessels, and wherein the function of time is determined experimentally to achieve a desired degree of bead loss during aspiration of the fluid.

B11. The method of any of paragraphs B0 through B10, wherein the function of time is determined based on a magnetic strength of the magnetic beads.

B12. The method of any of paragraphs B0 through B11, wherein the function of time is determined based on a magnetizability of the magnetic beads.

B13. The method of any of paragraphs B0 through B12, wherein the predetermined function of time includes translating the array of magnets between the first vertical position and the second vertical position over a time interval of at least 10% of a calculated separation time of the mixture.

C0. A system for magnetically separating magnetic particles from a fluid, the system comprising:
a plurality of sample vessels arranged in a first array;
a plurality of magnets arranged in a second array offset from the first array such that the plurality of magnets are disposed in spaces between the sample vessels;
a controller configured to vary the speed of a motor as a preselected function of time, wherein the motor is configured to vertically translate the plurality of magnets between:
   (a) a first position, wherein a first pole of each magnet is substantially level with or below bottom ends of the sample vessels; and
   (b) a second position, wherein the first pole is substantially level with or above a meniscus of fluid within the sample vessels.

C1. The system of paragraph C0, wherein the motor translates the array of magnets at a speed between 150 and 160 pulses per second.

C2. The system of paragraph C0 or C1, wherein the preselected function of time is determined based on a size of the magnetic particles.

C3. The system of any of paragraphs C0 through C2, wherein the preselected function of time is determined based on a viscosity of the fluid.

C4. The system of any of paragraphs C0 through C3, wherein the preselected function of time is determined based on a strength or size of the magnets.

C5. The system of any of paragraphs C0 through C4, wherein the plurality of wells comprises a microwell plate.

C6. The system of any of paragraphs C0 through C5, wherein the plurality of magnets are arranged such that each magnet acts primarily on four nearby wells.

C7. The system of any of paragraphs C0 through C6, wherein the plurality of magnets are continuously extended between the first position and the second position.

C8. The system of paragraph C7, wherein the plurality of magnets are extended between the first position and the second position at a constant speed.

C9. The system of any of paragraphs C0 through C7, wherein a travel speed of the magnets varies over time.

C10. The system of paragraph C0, wherein the preselected function of time is determined experimentally, based on a desired degree of pellet formation by the magnetic particles resulting from movement of the magnets.

C11. The system of any of paragraphs C0 through C10, wherein the preselected function of time is determined based on a magnetic strength of the magnetic beads.

C12. The system of any of paragraphs C0 through C11, wherein the preselected function of time is determined based on a magnetizability of the magnetic beads.

C13. The system of any of paragraphs C0 through C12, wherein the preselected function of time includes vertically translating the plurality of magnets over a time interval of at least 10% of a calculated separation time of the magnetic particles and the fluid.

D0. A system for magnetically separating magnetic beads from a fluid, the system comprising:
a plurality of sample vessels arranged in a first array;
a plurality of magnets arranged in a second array offset from the first array such that the plurality of magnets are extensible into spaces between the sample vessels;
a motor configured to vertically translate the plurality of magnets between:
   (a) a first position, wherein a first pole of each magnet is substantially level with or below bottom ends of the sample vessels; and
   (b) a second position, wherein the first pole is substantially level with or above a meniscus of fluid within the sample vessels; and
a controller configured to vary the speed of the motor as a predetermined function of time, such that a single bead pellet is formed within each sample vessel.

D1. The system of paragraph D0, wherein the motor translates the array of magnets at a speed between 150 and 160 pulses per second.

D2. The system of paragraph D0 or D1, wherein the predetermined function of time is determined based on a size of the magnetic particles.

D3. The system of any of paragraphs D0 through D2, wherein the function of time is determined based on a viscosity of the fluid.

D4. The system of any of paragraphs D0 through D3, wherein the function of time is determined based on a strength or size of the magnets.

D5. The system of any of paragraphs D0 through D4, wherein the plurality of sample vessels comprises a microwell plate.

D6. The system of any of paragraphs D0 through D5, wherein the plurality of magnets are arranged such that each magnet acts primarily on four nearby sample vessels.

D7. The system of any of paragraphs D0 through D6, wherein the plurality of magnets are continuously extended between the first position and the second position.

D8. The system of paragraph D7, wherein the plurality of magnets are extended between the stowed position and the deployed position at a constant speed.

D9. The system of any of paragraphs D0 through D7, wherein a travel speed of the magnets varies over time.

D10. The system of paragraph D0, wherein the function of time is determined experimentally, based on a desired degree of formation of the magnetic beads into a single pellet within each sample vessel.

D11. The system of any of paragraphs D0 through D10, wherein the predetermined function of time is determined based on a magnetic strength of the magnetic beads.

D12. The system of any of paragraphs D0 through D11, wherein the function of time is determined based on a magnetizability of the magnetic beads.

D13. The system of any of paragraphs D0 through D12, wherein the predetermined function of time includes vertically translating the plurality of magnets over a time interval of at least 10% of a calculated separation time of the magnetic beads and the fluid.

E0. A method for magnetically separating a mixture, the method comprising:
agitating a plate comprising one or more sample vessels containing the mixture;
instructing, by a motor controller, a motor to translate the one or more sample vessels between a first vertical position and a second vertical position relative to an array of magnets according to a predetermined function of time, causing magnetic particles to form into pellets within the sample vessels; and
aspirating fluid from the sample vessels;
wherein the predetermined function of time is determined based on minimizing loss of magnetic particles to a desired degree during the step of aspirating.

E1. The method of paragraph E0, wherein the motor translates the one or more sample vessels at a speed between 150 and 160 pulses per second.

E2. The method of paragraph E0 or E1, wherein the predetermined function of time is determined based on a size of magnetic beads included within the mixture.

E3. The method of any of paragraphs E0 through E2, wherein the predetermined function of time is determined based on a viscosity of a fluid included within the mixture.

E4. The method of any of paragraphs E0 through E3, wherein the predetermined function of time is determined based on a strength or size of the magnets.

E5 The method of any of paragraphs E0 through E4, wherein the plurality of sample vessels comprises a microwell plate.

E6. The method of any of paragraphs E0 through E5, wherein the array of magnets is arranged such that each magnet acts on four wells.

E7. The method of any of paragraphs E0 through E6, wherein the array of magnets is continuously extended between the stowed position and the deployed position.

E8. The method of paragraph E7, wherein the plurality of sample vessels is translated between the first vertical position and the second vertical position at a constant speed.

E9. The method of any of paragraphs E0 through E7, wherein a travel speed of the plurality of sample vessels varies over time. E10. The method of paragraph E0, further including aspirating fluid from the plurality of wells, and wherein the function of time is determined experimentally to achieve a desired degree of bead loss during aspiration of the fluid.

E11. The method of any of paragraphs E0 through E10, wherein the function of time is determined based on a magnetic strength of the magnetic beads.

E12. The method of any of paragraphs E0 through E11, wherein the function of time is determined based on a magnetizability of the magnetic beads.

E13. The method of any of paragraphs E0 through E12, wherein the predetermined function of time includes translating the plurality of sample vessels between the first vertical position and the second vertical position over a time interval of at least 10% of a calculated separation time of the mixture.

F0. A system for magnetically separating magnetic beads from a fluid, the system comprising:
a plurality of sample vessels arranged in a first array;
a plurality of magnets arranged in a second array offset from the first array such that the plurality of magnets are extensible into spaces between the sample vessels;
a motor configured to vertically translate the plurality of sample vessels between:
   (a) a first position, wherein a first pole of each magnet is substantially level with or below bottom ends of the sample vessels; and
   (b) a second position, wherein the first pole is substantially level with or above a meniscus of fluid within the sample vessels; and
a controller configured to vary the speed of the motor as a predetermined function of time, such that a single bead pellet is formed within each sample vessel.

F1. The system of paragraph F0, wherein the motor translates the plurality of sample vessels at a speed between 150 and 160 pulses per second.

F2. The system of paragraph F0 or F1, wherein the predetermined function of time is determined based on a size of the magnetic particles.

F3. The system of any of paragraphs F0 through F2, wherein the function of time is determined based on a viscosity of the fluid.

F4. The system of any of paragraphs F0 through F3, wherein the function of time is determined based on a strength or size of the magnets.

F5. The system of any of paragraphs F0 through F4, wherein the plurality of sample vessels comprises a microwell plate.

F6. The system of any of paragraphs F0 through F5, wherein the plurality of magnets are arranged such that each magnet acts primarily on four nearby sample vessels.

F7. The system of any of paragraphs F0 through F6, wherein the plurality of sample vessels are continuously extended between the first position and the second position.

F8. The system of paragraph F7, wherein the plurality of sample vessels are translated such that the plurality of magnets are extended between the stowed position and the deployed position at a constant speed.

F9. The system of any of paragraphs F0 through F7, wherein a travel speed of the sample vessels varies over time.

F10. The system of paragraph F0, wherein the function of time is determined experimentally, based on a desired degree of formation of the magnetic beads into a single pellet within each sample vessel.

F11. The system of any of paragraphs F0 through F10, wherein the predetermined function of time is determined based on a magnetic strength of the magnetic beads.

F12. The system of any of paragraphs F0 through F11, wherein the function of time is determined based on a magnetizability of the magnetic beads.

F13. The system of any of paragraphs F0 through F12, wherein the predetermined function of time includes vertically translating the plurality of sample vessels over a time interval of at least 10% of a calculated separation time of the magnetic beads and the fluid.

### Advantages, Features, and Benefits

The different embodiments and examples of the systems and methods for magnetically separating mixtures described herein provide several advantages over known solutions. For example, illustrative embodiments and examples described herein reduce mixture separation times when compared with conventional methods. With multiple washes, more time to wait for the bead pellet to form can add up to a lot of wasted time especially when performing multiple washes.

Additionally, and among other benefits, illustrative embodiments and examples described herein reduce bead loss resulting from aspiration of fluids by controlling the speed and trajectory of separating magnets to ensure more beads are concentrated in the pellet and fewer are left in suspension, to be washed away by repeated rinses.

Additionally, and among other benefits, illustrative embodiments and examples described herein provide a method of harvesting molecules from a solution with improved efficiency. Illustrative embodiments and examples described herein provide an improvement of a ratio of harvested molecules to molecules left behind during a separation process.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A method for magnetically separating magnetic beads from a fluid, the method comprising:
sending one or more commands to a motor controller, wherein the commands correspond to a desired movement path as a predetermined function of time, and wherein the motor controller causes a motor to cause relative motion between one or more sample vessels and an array of magnets, such that the array of magnets are transitionable between a stowed position and a deployed position; and
transitioning an array of magnets between the stowed position and the deployed position along the desired movement path as a predetermined function of time;
wherein the magnets are spaced apart from bottom ends of one or more sample vessels containing the fluid when the magnets are in the stowed position;
wherein the one or more sample vessels contain magnetic beads suspended by the fluid;
wherein a first pole of each magnet is aligned with a meniscus of fluid in an adjacent sample vessel when the magnets are in the deployed position; and
wherein the predetermined function of time is determined based on a desired degree of formation of the magnetic beads into a single pellet within each sample vessel.

2. The method of claim 1, wherein the predetermined function of time includes transitioning the array of magnets over a time interval of at least 10% of a calculated separation time of the magnetic beads and the fluid.

3. The method of claim 1, wherein the predetermined function of time is determined based on a size of the magnetic beads.

4. The method of claim 1, wherein causing relative motion between the one or more sample vessels and the array of magnets includes translating the array of magnets along the desired movement path.

5. The method of claim 1, wherein causing relative motion between the one or more sample vessels and the array of magnets includes translating the one or more sample vessels along the desired movement path.

6. The method of claim 1, wherein the array of magnets is continuously extended between the stowed position and the deployed position.

7. The method of claim 6, wherein the array of magnets is extended between the stowed position and the deployed position at a constant speed.

8. The method of claim 1, wherein a travel speed of the magnets relative to the one or more sample vessels varies over time.

9. A method for magnetically separating a mixture, the method comprising:
agitating a plate comprising one or more sample vessels containing the mixture;
instructing, by a motor controller, a motor to translate an array of magnets between a first vertical position and a second vertical position according to a predetermined function of time, causing magnetic particles to form into pellets within the one or more sample vessels; and
aspirating fluid from the sample vessels;
wherein the predetermined function of time is determined based on minimizing loss of magnetic particles to a desired degree during the step of aspirating.

10. The method of claim 9, wherein the predetermined function of time includes translating the array of magnets between the first vertical position and the second vertical position over a time interval of at least 10% of a calculated separation time of the mixture.

11. The method of claim 9, wherein the predetermined function of time is determined based on a magnetizability of the magnetic particles.

12. The method of claim 10, wherein the array of magnets is continuously extended between the first vertical position and the second vertical position.

13. The method of claim 10, wherein the array of magnets is extended between the first vertical position and the second vertical position at a constant speed.

14. The method of claim 10, wherein a travel speed of the array of magnets varies over time.

15. A system for magnetically separating magnetic beads from a fluid, the system comprising:
a plurality of sample vessels arranged in a first array;
a plurality of magnets arranged in a second array offset from the first array such that the plurality of magnets are extensible into spaces between the sample vessels;
a motor configured to vertically translate the plurality of magnets between:
(a) a first position, wherein a first pole of each magnet is substantially level with or below bottom ends of the sample vessels; and
(b) a second position, wherein the first pole is substantially level with or above a meniscus of fluid within the sample vessels; and
a controller configured to vary a speed of the motor as a predetermined function of time, such that a single bead pellet is formed within each sample vessel;
wherein the predetermined function of time is determined based on a desired degree of formation of the magnetic beads into the single bead pellet within each sample vessel.

16. The system of claim 15, wherein the plurality of sample vessels comprises a microwell plate.

17. The system of claim 15, wherein the plurality of magnets are arranged such that each magnet acts primarily on four nearby sample vessels.

18. The system of claim 15, wherein the plurality of magnets are continuously extended between the first position and the second position.

19. The system of claim 18, wherein the plurality of magnets are extended between the first position and the second position at a constant speed.

20. The system of claim 15, wherein a travel speed of the magnets varies over time.
